(19) United States
(12) Patent Application Publication
(10) Pub. No.: US 2026/0332340 A1
(43) Pub. Date: Oct. 22, 2026

(54) SINGLE-FREQUENCY NETWORK TRANSMISSION SCHEMES FOR SOUNDING REFERENCE SIGNALS

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 19/116,842

(22) PCT Filed: Dec. 2, 2022
(86) PCT No.: PCT/CN2022/136110

§ 371 Date: Mar. 28, 2025

(51) Int. Cl. H04L 5/00; H04B 7/06

(52) U.S. Cl. CPC H04L 5/0051; H04B 7/06952

(57) ABSTRACT

Methods, systems, and devices for wireless communications are described. Some wireless communications systems may support single frequency network (SFN) signaling to increase the signal strength and reliability for uplink and downlink data channel communications. In some systems, a user equipment (UE) may receive a control message that indicates a configuration of an SFN communication scheme for communicating one or more uplink sounding reference signals (SRSs). The control message may indicate respective antenna ports of the UE that are used for transmitting the one or more SRSs and are each associated with at least two directional beams. The UE may then transmit the one or more SRSs via the at least two directional beams in accordance with the SFN communication scheme.

### CROSS REFERENCE

The present Application is a 371 national phase filing of International PCT Application No. PCT/CN2022/136110 by YUAN et al., entitled “SINGLE-FREQUENCY NETWORK TRANSMISSION SCHEMES FOR SOUNDING REFERENCE SIGNALS,” filed Dec. 2, 2022, which is assigned to the assignee hereof, and which is expressly incorporated by reference in its entirety herein.

### TECHNICAL FIELD

The following relates generally to wireless communications, and more specifically to single-frequency network (SFN) transmission schemes for sounding reference signals (SRS).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support single-frequency network (SFN) transmission schemes for sounding reference signals (SRS). For example, the described techniques provide support for uplink transmissions using an SFN communication scheme to increase uplink coverage and throughput in a wireless communications system. To further support communications in the SFN, a user equipment (UE) may be configured to transmit uplink SRS using an SFN communication scheme to enable the network to estimate uplink channel quality. In such implementations, the UE may receive a control message (e.g., a radio resource control (RRC) message, a downlink control information (DCI) message, a medium access control-control element (MAC-CE), or any combination thereof) that indicates a configuration of the SFN communication scheme for transmitting one or more uplink SRSs. For example, respective antenna ports of the UE (allocated for transmitting one or more uplink SRSs) may be associated with at least two directional beams. Then, based on the received configuration, the UE may transmit the one or more SRSs via the at least two directional beams in accordance with the SFN communication scheme.

A method for wireless communication at a UE is described. The method may include receiving a control message indicating a configuration of a SFN communication scheme for one or more SRSs, where respective antenna ports of the UE for transmitting the one or more SRSs are each associated with at least two directional beams and transmitting the one or more SRSs via the at least two directional beams in accordance with the SFN communication scheme.

An apparatus for wireless communication at a UE is described. The apparatus may include at least one processor and memory coupled with the at least one processor, the memory storing instructions executable (e.g., directly, indirectly, without pre-processing, after pre-processing) by the at least one processor to cause the UE to receive a control message indicating a configuration of a SFN communication scheme for one or more SRSs, where respective antenna ports of the UE for transmitting the one or more SRSs are each associated with at least two directional beams and transmit the one or more SRSs via the at least two directional beams in accordance with the SFN communication scheme.

Another apparatus for wireless communication at a UE is described. The apparatus may include means for receiving a control message indicating a configuration of a SFN communication scheme for one or more SRSs, where respective antenna ports of the UE for transmitting the one or more SRSs are each associated with at least two directional beams and means for transmitting the one or more SRSs via the at least two directional beams in accordance with the SFN communication scheme.

A non-transitory computer-readable medium storing code for wireless communication at a UE is described. The code may include instructions executable by at least one processor to receive a control message indicating a configuration of a SFN communication scheme for one or more SRSs, where respective antenna ports of the UE for transmitting the one or more SRSs are each associated with at least two directional beams and transmit the one or more SRSs via the at least two directional beams in accordance with the SFN communication scheme.

Some examples of the method, apparatuses, and non-transitory computer-readable medium described herein may further include operations, features, means, or instructions for receiving a DCI message including a SRS resource indicator, a transmit precoding indicator, or both, that include an indication of at least two precoders to apply to the at least two directional beams and transmitting an uplink data channel via the at least two directional beams in accordance with the at least two precoders and the SFN communication scheme.

In some examples of the method, apparatuses, and non-transitory computer-readable medium described herein, the uplink data channel includes a codebook-based uplink data channel, and the at least two precoders may be based on the at least two directional beams associated with the SFN communication scheme for transmitting the one or more SRSs.

In some examples of the method, apparatuses, and non-transitory computer-readable medium described herein, the uplink data channel includes a non-codebook-based uplink data channel and the at least two precoders may be determined based on the at least two directional beams associated with the SFN communication scheme for transmitting a subset of the one or more SRSs.

Some examples of the method, apparatuses, and non-transitory computer-readable medium described herein may further include operations, features, means, or instructions for receiving two or more SRS resource indicators, two or more transmit precoding indicators, or a combination thereof, that include an indication of at least two precoders to apply to the at least two directional beams and transmitting an uplink data channel via the at least two directional beams in accordance with the at least two precoders and the SFN communication scheme.

In some examples of the method, apparatuses, and non-transitory computer-readable medium described herein, the uplink data channel includes a codebook-based uplink data channel, and the two or more SRS resource indicators, the two or more transmit precoding indicators, or the combination thereof, indicate the at least two precoders associated with a SFN transmission of the one or more SRSs.

In some examples of the method, apparatuses, and non-transitory computer-readable medium described herein, the uplink data channel includes a non-codebook-based uplink data channel, and the two or more SRS resource indicators indicate the at least two precoders associated with a SFN transmission of a subset of the one or more SRSs.

In some examples of the method, apparatuses, and non-transitory computer-readable medium described herein, the control message includes an RRC message and the method, apparatuses, and non-transitory computer-readable medium may include further operations, features, means, or instructions for applying, in accordance with the RRC message, the SFN communication scheme for a SRS resource set associated with each of the one or more SRSs.

In some examples of the method, apparatuses, and non-transitory computer-readable medium described herein, the control message includes an RRC message and the method, apparatuses, and non-transitory computer-readable medium may include further operations, features, means, or instructions for applying, in accordance with the RRC message, the SFN communication scheme for a SRS resource corresponding to at least one of the one or more SRSs that may be associated with a SRS resource set.

In some examples of the method, apparatuses, and non-transitory computer-readable medium described herein, the control message includes a DCI message, and transmitting the one or more SRSs may include operations, features, means, or instructions for transmitting the one or more aperiodic SRSs via the at least two directional beams in accordance with the SFN communication scheme indicated by the DCI message.

In some examples of the method, apparatuses, and non-transitory computer-readable medium described herein, the control message includes a medium access control-control element and transmitting the one or more SRSs may include operations, features, means, or instructions for transmitting the one or more semi-periodic SRSs via the at least two directional beams in accordance with the SFN communication scheme indicated by the MAC-CE.

In some examples of the method, apparatuses, and non-transitory computer-readable medium described herein, transmitting the one or more SRSs may include operations, features, means, or instructions for transmitting the one or more periodic SRSs via the at least two directional beams in accordance with the SFN communication scheme indicated by the RRC message.

In some examples of the method, apparatuses, and non-transitory computer-readable medium described herein, transmitting the one or more SRSs may include operations, features, means, or instructions for transmitting the one or more SRSs in accordance with the SFN communication scheme based on the one or more SRSs being associated with the at least two directional beams.

Some examples of the method, apparatuses, and non-transitory computer-readable medium described herein may further include operations, features, means, or instructions for receiving a DCI message that indicates one or more power control parameters corresponding to the at least two directional beams and applying the one or more power control parameters to the at least two directional beams based on the DCI message.

In some examples of the method, apparatuses, and non-transitory computer-readable medium described herein, the one or more power control parameters include a first power control parameter and a second power control parameter and the method, apparatuses, and non-transitory computer-readable medium may include further operations, features, means, or instructions for applying the first power control parameter to a first directional beam of the at least two directional beams and the second power control parameter to a second directional beam of the at least two directional beams.

In some examples of the method, apparatuses, and non-transitory computer-readable medium described herein, the one or more power control parameters include a single power control parameter and the method, apparatuses, and non-transitory computer-readable medium may include further operations, features, means, or instructions for applying the single power control parameter separately to a first directional beam of the at least two directional beams and to a second directional beam of the at least two directional beams.

In some examples of the method, apparatuses, and non-transitory computer-readable medium described herein, the one or more power control parameters include a single power control parameter and the method, apparatuses, and non-transitory computer-readable medium may include further operations, features, means, or instructions for applying a first portion of the single power control parameter to a first directional beam of the at least two directional beams and a second portion of the single power control parameter to a second directional beam of the at least two directional beams.

In some examples of the method, apparatuses, and non-transitory computer-readable medium described herein, the DCI message includes a group common DCI message, a first DCI message format, a second DCI message format, or any combination thereof.

In some examples of the method, apparatuses, and non-transitory computer-readable medium described herein, the at least two directional beams may be associated with at least two unified transmission configuration indicator (TCI) states, at least two spatial relation information parameters, or any combination thereof.

A method for wireless communication at a network entity is described. The method may include transmitting a control message indicating a configuration of a SFN communication scheme for one or more SRSs, where the SFN communication scheme is configured for respective antenna ports associated with the one or more SRSs that are each associated with at least two directional beams and receiving the one or more SRSs via the at least two directional beams in accordance with the SFN communication scheme.

An apparatus for wireless communication at a network entity is described. The apparatus may include at least one processor and memory coupled with the at least one processor, the memory storing instructions executable (e.g., directly, indirectly, without pre-processing, after pre-processing) by the at least one processor to cause the network entity to transmit a control message indicating a configuration of a SFN communication scheme for one or more SRSs, where the SFN communication scheme is configured for respective antenna ports associated with the one or more SRSs that are each associated with at least two directional beams and receive the one or more SRSs via the at least two directional beams in accordance with the SFN communication scheme.

Another apparatus for wireless communication at a network entity is described. The apparatus may include means for transmitting a control message indicating a configuration of a SFN communication scheme for one or more SRSs, where the SFN communication scheme is configured for respective antenna ports associated with the one or more SRSs that are each associated with at least two directional beams and means for receiving the one or more SRSs via the at least two directional beams in accordance with the SFN communication scheme.

A non-transitory computer-readable medium storing code for wireless communication at a network entity is described. The code may include instructions executable by at least one processor to transmit a control message indicating a configuration of a SFN communication scheme for one or more SRSs, where the SFN communication scheme is configured for respective antenna ports associated with the one or more SRSs that are each associated with at least two directional beams and receive the one or more SRSs via the at least two directional beams in accordance with the SFN communication scheme.

Some examples of the method, apparatuses, and non-transitory computer-readable medium described herein may further include operations, features, means, or instructions for transmitting one or more SRS resource indicators, one or more transmit precoding indicators, or any combination thereof, that include an indication of at least two precoders to apply to the at least two directional beams and receiving an uplink data channel via the at least two directional beams in accordance with the at least two precoders and the SFN communication scheme.

In some examples of the method, apparatuses, and non-transitory computer-readable medium described herein, receiving the one or more SRSs may include operations, features, means, or instructions for receiving, based on the RRC message, each of the one or more SRSs that may be associated with a SRS resource set, the SRS resource set being configured with the SFN communication scheme.

In some examples of the method, apparatuses, and non-transitory computer-readable medium described herein, receiving the one or more SRSs may include operations, features, means, or instructions for receiving, based on the RRC message, at least one of the one or more SRSs that may be associated with a SRS resource set, respective SRS resources associated with the at least one of the one or more SRSs being configured with the SFN communication scheme.

In some examples of the method, apparatuses, and non-transitory computer-readable medium described herein, receiving the one or more SRSs may include operations, features, means, or instructions for receiving the one or more aperiodic SRSs via the at least two directional beams in accordance with the SFN communication scheme indicated by the DCI message.

In some examples of the method, apparatuses, and non-transitory computer-readable medium described herein, receiving the one or more SRSs may include operations, features, means, or instructions for receiving the one or more semi-periodic SRSs via the at least two directional beams in accordance with the SFN communication scheme indicated by the MAC-CE.

In some examples of the method, apparatuses, and non-transitory computer-readable medium described herein, receiving the one or more SRSs may include operations, features, means, or instructions for receiving the one or more periodic SRSs via the at least two directional beams in accordance with the SFN communication scheme indicated by the RRC message.

Some examples of the method, apparatuses, and non-transitory computer-readable medium described herein may further include operations, features, means, or instructions for transmitting a DCI message that indicates one or more power control parameters corresponding to the at least two directional beams and receiving signaling via the at least two directional beams based on the one or more power control parameters and the DCI message.

In some examples of the method, apparatuses, and non-transitory computer-readable medium described herein, the one or more power control parameters correspond to both a first directional beam of the at least two directional beams and a second directional beam of the at least two directional beams.

### BRIEF DESCRIPTION OF THE DRAWINGS

FIGS. 1, 2, 3A, and 3B illustrate examples of wireless communications systems that support single-frequency network (SFN) transmission schemes for sounding reference signals (SRS) in accordance with one or more aspects of the present disclosure.

FIG. 4 illustrates an example of a process flow that supports SFN transmission schemes for SRS in accordance with one or more aspects of the present disclosure.

FIGS. 5 and 6 illustrate block diagrams of devices that support SFN transmission schemes for SRS in accordance with one or more aspects of the present disclosure.

FIG. 7 illustrates a block diagram of a communications manager that supports SFN transmission schemes for SRS in accordance with one or more aspects of the present disclosure.

FIG. 8 illustrates a diagram of a system including a device that supports SFN transmission schemes for SRS in accordance with one or more aspects of the present disclosure.

FIGS. 9 and 10 illustrate block diagrams of devices that support SFN transmission schemes for SRS in accordance with one or more aspects of the present disclosure.

FIG. 11 illustrates a block diagram of a communications manager that supports SFN transmission schemes for SRS in accordance with one or more aspects of the present disclosure.

FIG. 12 illustrates a diagram of a system including a device that supports SFN transmission schemes for SRS in accordance with one or more aspects of the present disclosure.

FIGS. 13 through 16 illustrate flowcharts showing methods that support SFN transmission schemes for SRS in accordance with one or more aspects of the present disclosure.

### DETAILED DESCRIPTION

Some wireless communications systems may support single frequency network (SFN) communications schemes to increase system throughput and coverage. Some such SFN communications schemes may implement broadcast signaling where several wireless devices can simultaneously transmit a same signal over a same frequency channel, where several other wireless devices can receive a superposition of the transmitted signals. SFN operation may be implemented in downlink systems, for example, to increase the signal strength and reliability for downlink channels and associated downlink communications (e.g., via the physical downlink control channel (PDCCH) and the physical downlink shared channel (PDSCH)). SFN operation may also be applied for uplink channels to increase uplink throughput and reliability of associated uplink communications (e.g., via a physical uplink control channel (PUCCH) and a physical uplink shared channel (PUSCH)).

To further support uplink transmissions using an SFN communication scheme, a user equipment (UE) may be configured to transmit uplink sounding reference signals (SRS) using an SFN communication scheme to enable the network to estimate uplink channel quality, among other functions. For example, the UE may be configured to transmit one or more SRS using the SFN communication scheme, where each SRS port of the UE (e.g., antenna ports configured to transmit SRS) may be associated with two directional beams (e.g., two unified transmission configuration indicator (TCI) states, or two spatial relation information parameters). The UE may then use the two directional beams to transmit SRS from the SRS port on a single frequency.

In some examples, the UE may receive an SFN indication for an SRS via radio resource control (RRC) signaling for transmissions of periodic SRS, downlink control information (DCI) for transmissions of aperiodic SRS, medium access control-control element (MAC-CE) signaling for semi-periodic SRS, or other control signaling based on various conditions. For example, the SFN indication for SRS may be RRC configured per SRS resource set (e.g., where each SRS in the SRS resource set are enabled with SFN transmission) or individually for each SRS resource (e.g., where at least one SRS in the SRS resource set is enabled with SFN transmission). In some other examples, the UE may determine the SFN indication for SRS based on the number of beams configured for the SRS (e.g., if two beams are configured for SRS, the UE may implicitly determine an SFN transmission for the SRS).

In some other implementations, the UE may receive signaling from the network (e.g., via one or more SRS resource indicators or transmit precoding indicators) that include an indication of one or more precoders to apply to the multiple beams used to transmit the SRS. Further, the UE may be configured with different power control commands for SFN transmissions of SRS. For example, the UE may receive power control commands via DCI to apply to SFN transmissions of SRS to reduce excess power expenditure.

Aspects of the disclosure are initially described in the context of wireless communications systems. Aspects of the disclosure are further illustrated by and described with reference to a process flow, apparatus diagrams, system diagrams, and flowcharts that relate to SFN transmission schemes for SRS.

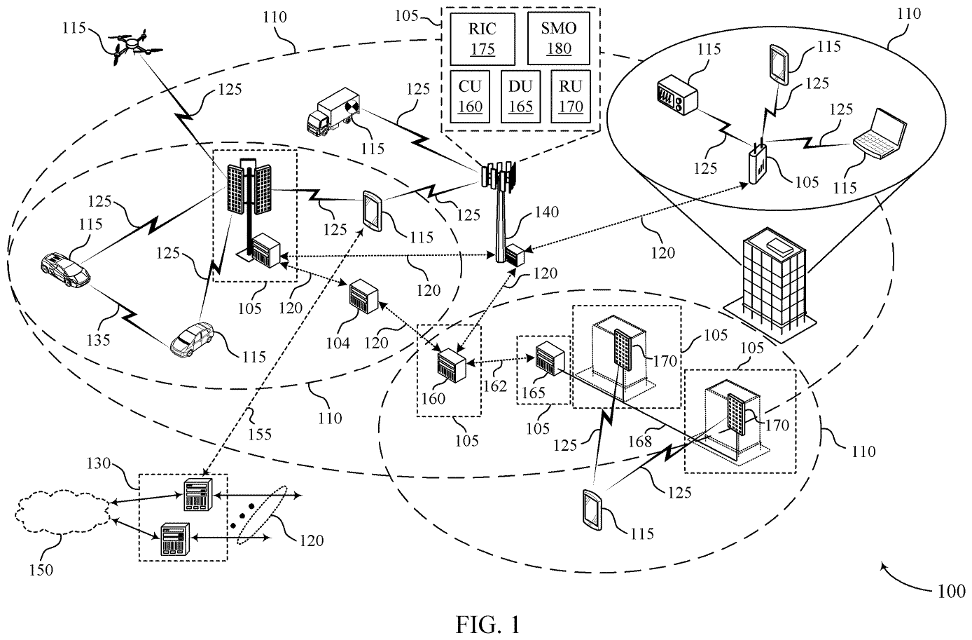

FIG. 1 illustrates an example of a wireless communications system 100 that supports SFN transmission schemes for SRS in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support SFN transmission schemes for SRS as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, drones, robots, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

Wireless communications system 100 may support a unified transmission configuration indicator (TCI) framework, where a wireless device may use a common beam for communications via uplink and downlink channels, for example, in cases where a UE 115 support multi-transmission reception point (mTRP) communications. In such cases, a network entity 105 may indicate, to a UE 115, multiple downlink and uplink TCI states to use for mTRP communications. In some examples, a UE 115 may support simultaneous multi-panel uplink transmission (for example, in an SFN) to increase uplink throughput and reliability in high frequency (e.g., FR2) systems support mTRP. In such examples, the UE 115 may support up to two TRPs and up to two panels to communicate with multiple TRPs, network devices, customer premise equipment (CPE), fixed wireless access (FWA) devices, vehicle, industrial devices, or any combination thereof.

In some examples, a UE 115 may support one or more precoding indications for PUSCH, including a precoding codebook for multi-panel simultaneous transmissions. In such cases, the UE 115 may support four layers and two codewords across all panels (e.g., for single DCI and multi-DCI based mTRP operation). In addition, the UE 115 may support uplink beam indication for PUCCH and PUSCH, using the unified TCI framework (e.g., for the single DCI and multi-DCI based multi-TRP operation). In some examples of the multi-DCI based mTRP operation, the UE 115 may transmit PUSCH and PUSCH, or PUCCH and PUCCH across two panels in a same component carrier. In some other examples, the UE 115 may support one or more timing advances for uplink multi-DCI mTRP operation, power control techniques for UL single DCI for mTRP operation and unified TCI.

The UE 115 may support a unified TCI framework, where uplink and downlink channels may be controlled by a common framework (e.g., in addition to or instead of defining the TCI state or spatial relationship for each channel). For unified TCI, the UE 115 may identify and apply a common beam to uplink and downlink channels. Additionally, or alternatively, a common beam for uplink may be applied to uplink channels, and a common beam for downlink may be applied to downlink channels. In some examples, the UE 115 may support one common beam for both downlink and uplink, or a common beam for downlink and a common beam for uplink (e.g., two common beams in total). In such unified TCI frameworks, the UE 115 may apply the same TCI state (e.g., a joint TCI state, a joint TCI state pool, a joint common TCI state pool) for uplink and/or downlink communications channels.

In some examples of the unified TCI framework, the UE 115 may support a joint TCI state that indicates a common beam for at least one downlink channel, downlink reference signal, or both, in addition to at least one uplink channel, uplink reference signal, or both. The first type of unified TCI framework may include at least UE-specific PDCCH, PDSCH, PUCCH, and PUSCH. In some other examples of the unified TCI framework, the UE 115 may support a separate downlink TCI state to indicate a common beam for more than one downlink channel, downlink reference signal, or both, including at least a UE-specific PDCCH and PDSCH. In some other examples of the unified TCI framework, the UE 115 may support separate uplink TCI states to indicate a common beam for more than one uplink channel, uplink reference signal, or both, including at least one UE-specific PUCCH and PUSCH.

In some examples, the UE 115 may apply the unified TCI framework reduce signaling overhead and latency in multi-beam operations and for mTRP operations. For example, the UE 115 may indicate a common beam or common quasi-colocation (QCL) parameters for multiple channels and signals for communicating with a first TRP and a second TRP. In such cases, even if a beam is subject to blockage or reduced signaling quality for communications with the first TRP, the common beam may still be used for communications with the second TRP, and the UE 115 may retain communications with the second TRP while switching to a different beam to communicate with the first TRP.

In some examples, for SFN communications, the UE 115 may use the same time and frequency resources and different beams to increase system throughput and coverage. Some such SFN communications may be implemented in downlink systems, for example, to increase the signal strength and reliability for downlink channels and associated downlink communications. SFN communications may also be applied for uplink channels to increase uplink throughput and reliability of associated uplink communications. To further support uplink transmissions using an SFN communication scheme, a UE 115 may be configured to transmit uplink SRSs using the SFN communication scheme to enable a network entity 105 to estimate uplink channel quality. For example, the UE 115 may be configured to transmit SRS using an SFN communication scheme, where each SRS port of the UE 115 may be associated with two directional beams. The UE 115 may then use the two directional beams to transmit SRS from the SRS port on a single frequency.

In some examples, the UE 115 may receive an SFN indication for an SRS via RRC signaling for transmissions of periodic SRS, DCI for transmissions of aperiodic SRS, MAC-CE signaling for semi-periodic SRS, or other control signaling. For example, the SFN indication for SRS may be RRC configured per SRS resource set (e.g., where each SRS in the SRS resource set are enabled with SFN transmission) or individually for each SRS resource (e.g., where at least one SRS in the SRS resource set is enabled with SFN transmission). In some other implementations, the UE 115 may receive signaling from the network (e.g., via one or more SRS resource indicators or transmit precoding indicators) that include an indication of one or more precoders to apply to the multiple beams used to transmit the SRS. Additionally, or alternatively, the UE 115 may be configured with different power control commands for SFN transmissions of SRS to reduce power expenditure and increase signaling efficiency.

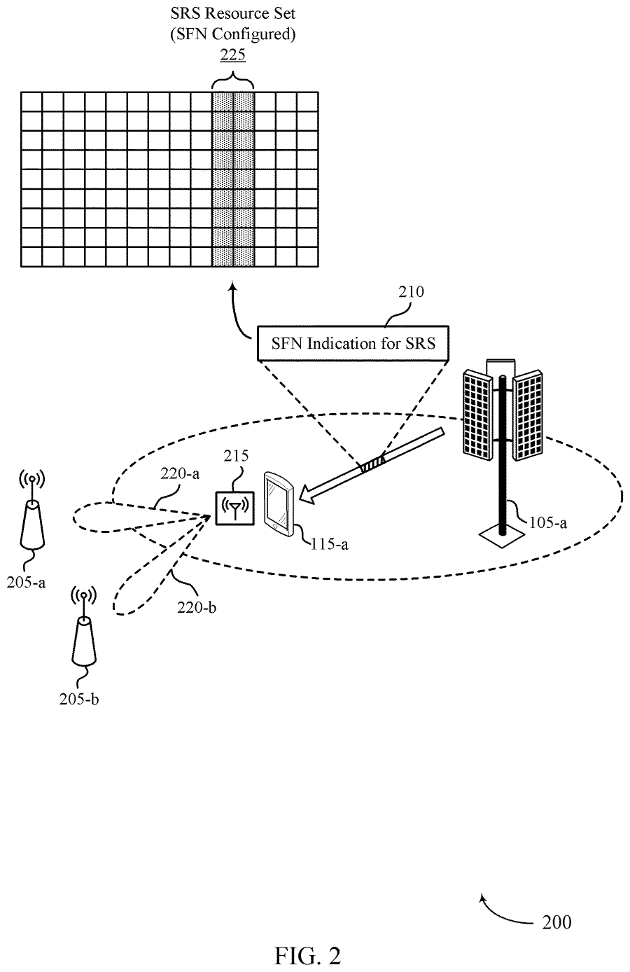

FIG. 2 illustrates an example of a wireless communications system 200 that supports SFN transmission schemes for SRS in accordance with one or more aspects of the present disclosure. For example, the wireless communications system 200 may support communications between a network entity 105-a and a UE 115-a, each of which may be examples of network entities 105 and UEs 115 described with reference to FIG. 1. In addition, wireless communications system 200 may support mTRP communications between the UE 115-a and one or more TRPs, for example, TRP 205-a and TRP 205-b.

In some implementations, the wireless communications system 200 may be an example of a broadcast network supporting SFN communications. For example, a transmitting wireless device (e.g., UE 115-a, TRP 205-a, TRP 205-b, and network entity 105-a) may simultaneously transmit a same signal over a same frequency channel, and a receiving wireless device may receive a set of superpositioned signals on a same frequency. In some cases, SFN operation is used for downlink communications, for example, to increase the signal strength and reliability for a downlink data channel and downlink data channel communications (e.g., PDCCH and PDSCH communications), communicated between the network entity 105-a and the UE 115-a. In some other examples, the wireless communications system 200 may support SFN operation for uplink communications to increase uplink throughput and reliability of uplink data channel and uplink control channel communications (e.g., PUSCH and PUCCH communications) communicated between the UE 115-a and the network entity 105-a, the TRP 205-a, the TRP 205-b. or a combination thereof.

To support SFN communications for uplink channels, the UE 115-a may transmit uplink SRSs to provide information about one or more effects of multipath fading, scattering, Doppler, or power loss of a transmitted signal. SRSs may be uplink physical signals employed by the UE 115-a for uplink channel sounding, including channel quality estimation and synchronization, which may increase the accuracy of uplink timing and synchronization for the SFN communications. For example, the UE 115-a may receive an SFN indication 210 which configures the UE 115-a with an SFN transmission for uplink SRS. In some examples, the SFN indication may specify that each SRS port 215 of the UE 115-a may be transmitted by two beams (e.g., beam 220-a and beam 220-b) corresponding to two unified TCIs or two spatial relation information configurations. The UE 115-a may then transmit the uplink SRS (e.g., to the TRP 205-a, the TRP 205-b, or the network entity 105-a) via two beams in the SFN based on the configuration for uplink SRS in the SFN.

In some examples, the SFN indication 210 may be RRC configured (e.g., via an RRC message) per SRS resource set 225. For example, the RRC configuration may specify that each SRS resource in the SRS resource set 225 may support SFN transmissions. In some other examples, the SFN indication 210 may be RRC configured per SRS resource. For example, the RRC configuration may specify one or more SRS resources in an SRS resource set 225 that support SFN transmissions.

In some other examples, the SFN indication 210 may be indicated via SRS triggering signaling (e.g., via a DCI, MAC-CE, or RRC message). For example, the SFN indication 210 be conveyed via a DCI to indicate SFN transmission of aperiodic SRS, the SFN indication 210 may be conveyed via a MAC-CE to indicate SFN transmission of a semi-periodic SRS, and the SFN indication 210 may be conveyed via an RRC message to indicate SFN transmission of a periodic SRS.

In some other examples, the SFN indication 210 may indicate a number of beams (e.g., beam 220-a and beam 220-b) that the UE 115-a may use for transmitting uplink SRS. In such examples, the UE 115-a may implicitly determine to transmit the uplink SRS via an SFN communication scheme. For example, if the SFN indication 210 indicates two beams (e.g., two TCIs or two spatial relation information) for an SRS, the UE 115-a may transmit the SRS using the SFN transmission scheme. Additionally, or alternatively, if the UE 115-a receives an indication that configures one beam for transmission of the SRS, the UE 115-a may use a multiple frequency network communications scheme or some other non-SFN communication scheme to transmit the uplink SRS.

In some other examples, the SFN indication 210 may include explicit signaling from the network entity 105-a (e.g., via one or more SRS resource indicators (SRIs) or transmit precoding matrix indicators (TPMI)) that include an indication of one or more precoders to apply to beam 220-a and beam 220-b that are used to transmit the SRS. Additionally, or alternatively the SFN indication 210 may include an indication of one or more different power control commands for SFN transmissions of SRS. For example, the UE 115-a may receive an indication one or more receive power control commands to apply to SFN transmissions of SRS to reduce excess power expenditure.

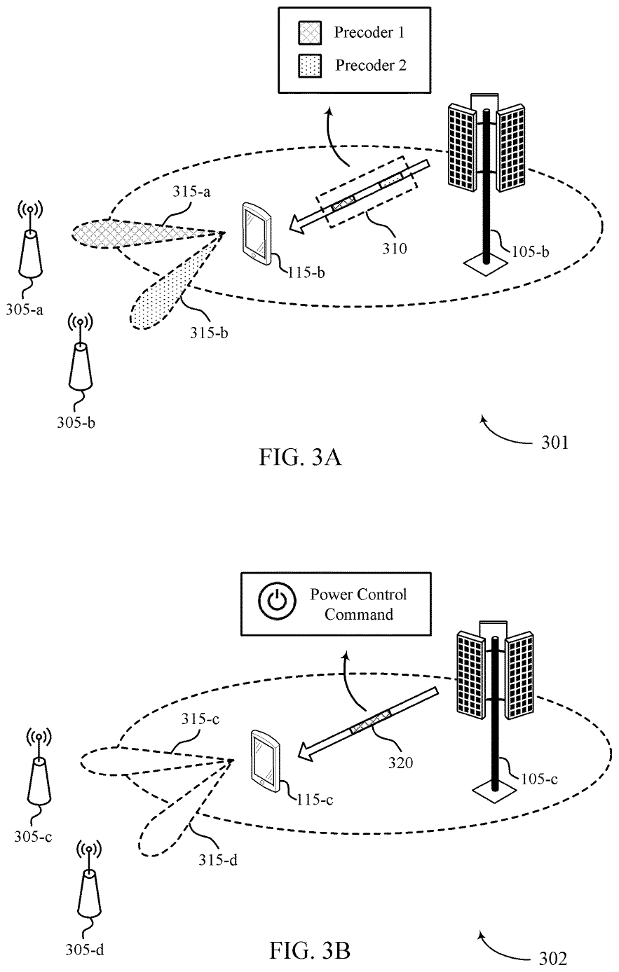

FIGS. 3A and 3B illustrate examples of wireless communications system 301 and wireless communications system 302 that support SFN transmission schemes for SRS in accordance with one or more aspects of the present disclosure. For example, the wireless communications system 301 may support communications between a network entity 105-b and a UE 115-b, and the wireless communications system 302 may support communications between a network entity 105-c and a UE 115-c, each of which may be examples of network entities 105 and UEs 115 described with reference to FIGS. 1 and 2. In addition, wireless communications system 301 and wireless communications system 302 may support mTRP communications between the UE 115-b, the UE 115-c and one or more TRPs, for example, TRP 305-a, TRP 305-b, TRP 305-c, and TRP 305-d, respectively.

FIG. 3A may illustrate a SFN communications scheme for PUSCH transmissions, where the UE 115-b may be configured with an SFN transmission for an uplink SRS resource set via the SFN indication 310. For example, the SRS resource set usage may be configured as codebook-based or non-codebook-based for the PUSCH transmission, and the SFN indication 310 may include one or more precoders (e.g., precoder 1 and precoder 2) that the UE 115-b may use for transmissions of the PUSCH.

For example, the SFN indication 310 may include a single SRI, a single TPMI, or both, which may include an indication of two precoders that the UE 115-a may apply to beam 315-a and beam 315-b. The UE 115-a may apply the two precoders to the two beams to transmit SRS via two beams per SRS port in the SFN. For codebook based PUSCH, the SRI, the TPMI, or both, may indicate the two precoders used in the SFN transmission for the indicated SRS resource (e.g., based on one or more defined precoder values). For example, the UE 115-b may determine the two beams for the SFN PUSCH transmission based on the two beams used for the SFN transmission of the indicated SRS resource. Additionally, or alternatively, for non-codebook based PUSCH, the SRI, the TPMI, or both, indicates two precoders used in the SFN transmission for the indicated subset of SRS resources. For example, the UE 115-b may calculate the values of the two precoders based on downlink reference signaling.

In some other implementations, the SFN indication 310 may indicate two SRIs, two TPMIs, or a combination thereof, which indicate two precoders for the PUSCH. For codebook-based PUSCH, the two SRI, the TPMI, or the combination thereof, indicate the two precoders used in the SFN transmission for two corresponding indicated SRS resources. For non-codebook based PUSCH, the two SRIs, the two TPMIs, or the combination thereof, indicate the two precoders used in the SFN transmission for two corresponding indicated subset of SRS resources. The first indicated precoder may be associated with the first beam of the indicated SRSs, and the second indicated precoder may be associated with the second beam of the indicated SRSs.

FIG. 3B may illustrate a SFN communications scheme for uplink SRS, where the UE 115-c may receive one or more power control commands via the SFN indication 320. For example, the SFN indication 320 may be a DCI (e.g., a group common DCI, a DCI 0_1 or DCI 0_2) that may indicate two separate power control commands or a shared power control command to apply to the beam 315-c and the beam 315-d for transmitting the SRS. In such examples, the two separate power control commands may be mapped and applied to the beam 315-c and the beam 315-d. In some other examples, the SFN indication 320 may be a DCI (e.g., a group common DCI, a DCI format 0_1 or DCI format 0_2) that may indicate a single power control to apply to both the beam 315-c and the beam 315-d for transmitting the SRS. For example, the single power control command may be mapped and applied to both the beam 315-c and the beam 315-d. Additionally, or alternatively, the single power control command may be split and applied to both the beam 315-c and the beam 315-d, where the total transmit power is shared between the two beams.

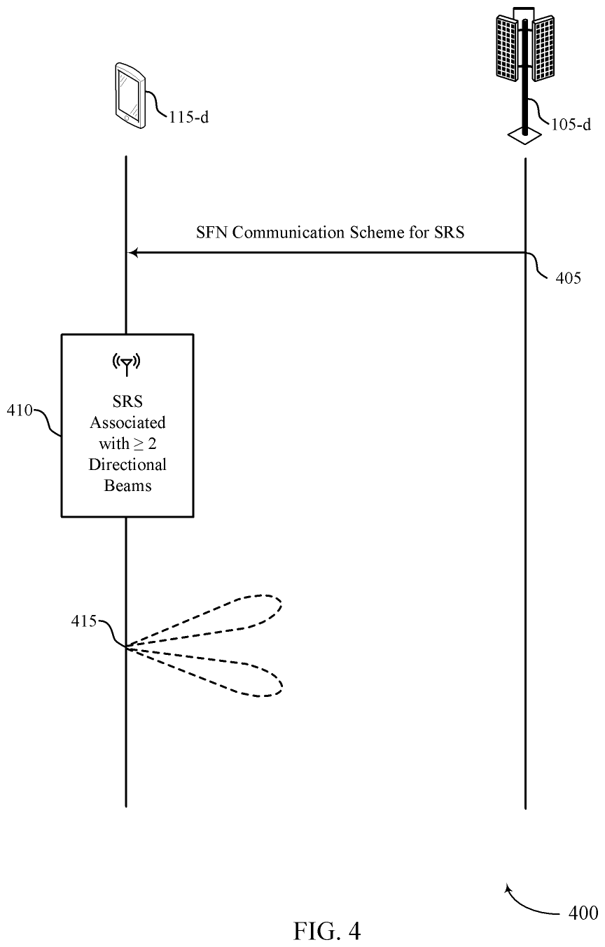

FIG. 4 illustrates an example of a process flow 400 that supports SFN transmission schemes for SRS in accordance with one or more aspects of the present disclosure. For example, the process flow 400 may support SFN communications between a UE 115-d and a network entity 105-d, which may be examples of corresponding devices described herein. In the following description of process flow 400, the operations between the UE 115-d and the network entity 105-d may be transmitted in a different order than the order shown, or other operations may be added or removed from the process flow 400. For example, some operations may also be left out of process flow 400, may be performed in different orders or at different times, or other operations may be added to process flow 400. Although UE 115-d and network entity 105-d are shown performing the operations of process flow 400, some aspects of some operations may also be performed by one or more other wireless or network devices.

At 405, the network entity 105-d may transmit, and the UE 115-d may receive, a control message that indicates a configuration of a SFN communication scheme for one or more SRSs. In some examples, respective antenna ports of the UE 115-d may be allocated for transmitting the one or more SRSs, and may each be associated with at least two directional beams at 410. The at least two directional beams may be associated with at least two unified TCI states, at least two spatial relation information parameters, or any combination thereof.

In some examples, the control message may be a DCI that includes one or more SRI, one or more TPMI, or a combination thereof, that indicate at least two precoders to apply to the at least two directional beams. In some examples, the one or more SRIs, the one or more TPMIs, or the combination thereof, indicate the at least two precoders associated with a SFN transmission of the one or more SRSs or a subset of the one or more SRSs.

In some examples, the control message may be an RRC message and the UE 115-d may apply the SFN communication scheme for an SRS resource set associated with each of the one or more SRSs. In some other examples, the UE 115-d may apply the SFN communication scheme for a SRS resource corresponding to at least one of the one or more SRSs that are associated with a SRS resource set. In some other examples, the UE 115-d may transmit one or more periodic SRSs via the at least two directional beams in accordance with the SFN communication scheme.

In some other examples, the control message may be a DCI message, and the UE 115-d may transmit one or more aperiodic SRSs via the at least two directional beams in accordance with the SFN communication scheme indicated by the DCI. In other examples, the control message may be a MAC-CE, and the UE 115-d may transmit one or more semi-periodic SRSs via the at least two directional beams in accordance with the SFN communication scheme indicated by the MAC-CE.

At 415, the UE 115-d may transmit the one or more SRSs on an uplink data channel via the at least two directional beams in accordance with the SFN communication scheme. In some examples, the UE 115-d may transmit the one or more SRSs via the at least two directional beams after applying the at least two precoders to the at least two directional beams. In some examples, the uplink data channel comprises a codebook-based uplink data channel, and the at least two precoders are based on the at least two directional beams associated with the SFN communication scheme for transmitting the one or more SRSs. In some other examples, the uplink data channel is a non-codebook-based uplink data channel, and the at least two precoders are determined based on the at least two directional beams associated with the SFN communication scheme for transmitting a subset of the one or more SRSs.

In some examples, the UE 115-d may transmit the one or more SRSs using one or more power control parameters. For example, the UE 15-d may receive a DCI message (e.g., a group common DCI message, a first DCI message format, a second DCI message format, or any combination thereof) that indicates one or more power control parameters corresponding to the at least two directional beams, and the UE 115-d may apply the one or more power control parameters to the at least two directional beams based on the DCI message. In some implementations, the DCI message may indicate a first power control parameter and a second power control parameter, and the UE 115-d may apply the first power control parameter to a first directional beam of the at least two directional beams and the second power control parameter to a second directional beam of the at least two directional beams. In some other implementations, the DCI message may indicate a single power control parameter, and the UE 115-d may apply a first portion of the single power control parameter to a first directional beam of the at least two directional beams and a second portion of the single power control parameter to a second directional beam of the at least two directional beams (e.g., the UE 115-d may split the total power between the at least two directional beams).

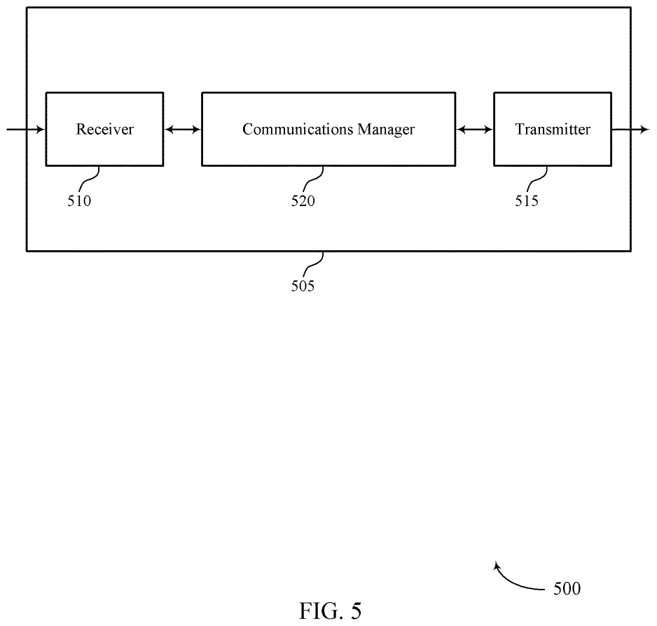

FIG. 5 illustrates a block diagram 500 of a device 505 that supports SFN transmission schemes for SRS in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to SFN transmission schemes for SRS). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to SFN transmission schemes for SRS). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of SFN transmission schemes for SRS as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, at least one processor and memory coupled with the at least one processor may be configured to perform one or more of the functions described herein (e.g., by executing, by the at least one processor, instructions stored in the memory).

Additionally, or alternatively, in some examples, the communications manager 520, the receiver 510, the transmitter 515, or various combinations or components thereof may be implemented in code (e.g., as communications management software) executed by a processor. If implemented in code executed by a processor, the functions of the communications manager 520, the receiver 510, the transmitter 515, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for receiving a control message indicating a configuration of a SFN communication scheme for one or more SRS, where respective antenna ports of the UE for transmitting the one or more SRS are each associated with at least two directional beams. The communications manager 520 may be configured as or otherwise support a means for transmitting the one or more SRS via the at least two directional beams in accordance with the SFN communication scheme.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources, increased coverage and reliability, improved power savings, and increased throughput.

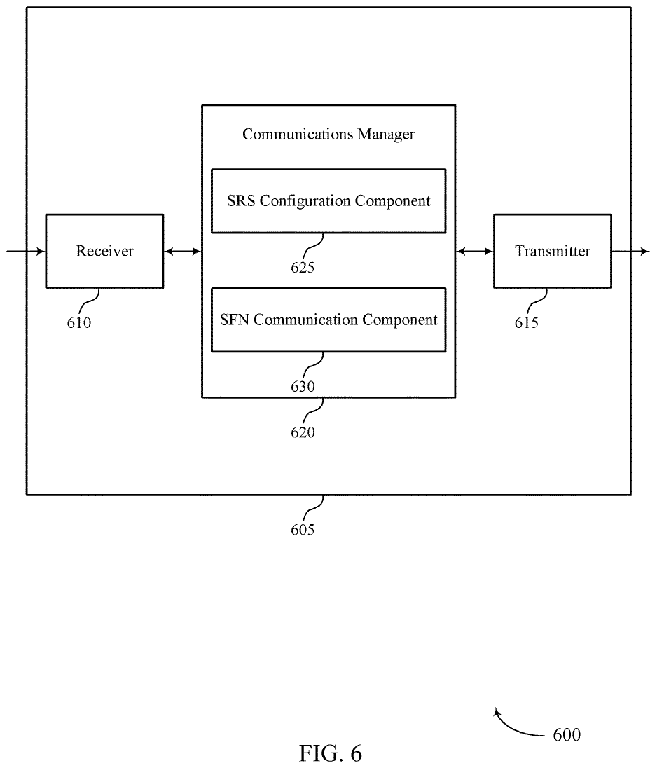

FIG. 6 illustrates a block diagram 600 of a device 605 that supports SFN transmission schemes for SRS in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to SFN transmission schemes for SRS). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to SFN transmission schemes for SRS). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of SFN transmission schemes for SRS as described herein. For example, the communications manager 620 may include an SRS configuration component 625 an SFN communication component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The SRS configuration component 625 may be configured as or otherwise support a means for receiving a control message indicating a configuration of a SFN communication scheme for one or more SRS, where respective antenna ports of the UE for transmitting the one or more SRS are each associated with at least two directional beams. The SFN communication component 630 may be configured as or otherwise support a means for transmitting the one or more SRS via the at least two directional beams in accordance with the SFN communication scheme.

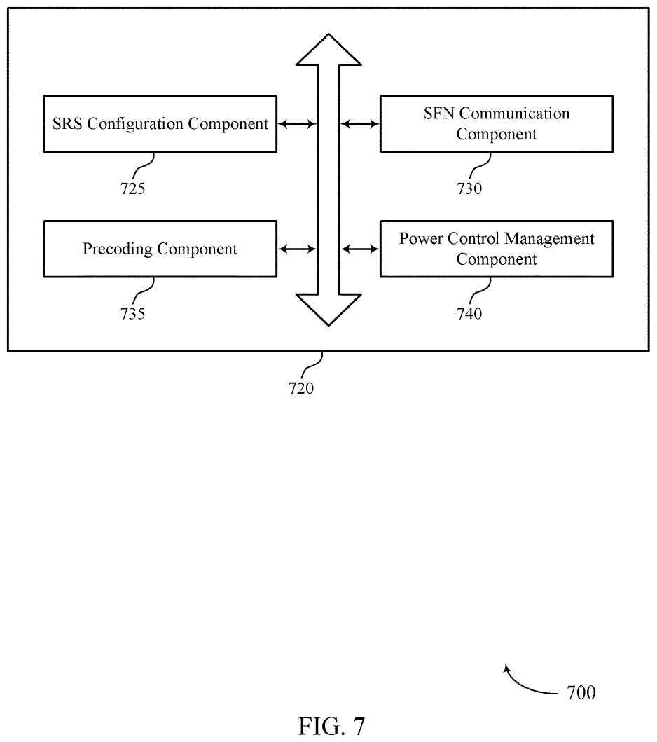

FIG. 7 illustrates a block diagram 700 of a communications manager 720 that supports SFN transmission schemes for SRS in accordance with one or more aspects of the present disclosure. The communications manager 720 may be an example of aspects of a communications manager 520, a communications manager 620, or both, as described herein. The communications manager 720, or various components thereof, may be an example of means for performing various aspects of SFN transmission schemes for SRS as described herein. For example, the communications manager 720 may include an SRS configuration component 725, an SFN communication component 730, a precoding component 735, a power control management component 740, or any combination thereof. Each of these components may communicate, directly or indirectly, with one another (e.g., via one or more buses).

The communications manager 720 may support wireless communication at a UE in accordance with examples as disclosed herein. The SRS configuration component 725 may be configured as or otherwise support a means for receiving a control message indicating a configuration of a SFN communication scheme for one or more SRS, where respective antenna ports of the UE for transmitting the one or more SRS are each associated with at least two directional beams. The SFN communication component 730 may be configured as or otherwise support a means for transmitting the one or more SRS via the at least two directional beams in accordance with the SFN communication scheme.

In some examples, the precoding component 735 may be configured as or otherwise support a means for receiving a DCI message including a SRS resource indicator, a transmit precoding indicator, or both, that include an indication of at least two precoders to apply to the at least two directional beams. In some examples, the SFN communication component 730 may be configured as or otherwise support a means for transmitting an uplink data channel via the at least two directional beams in accordance with the at least two precoders and the SFN communication scheme.

In some examples, the uplink data channel includes a codebook-based uplink data channel, and the at least two precoders are based on the at least two directional beams associated with the SFN communication scheme for transmitting the one or more SRS.

In some examples, the uplink data channel includes a non-codebook-based uplink data channel. In some examples, the at least two precoders are determined based on the at least two directional beams associated with the SFN communication scheme for transmitting a subset of the one or more SRS.

In some examples, the precoding component 735 may be configured as or otherwise support a means for receiving two or more SRS resource indicators, two or more transmit precoding indicators, or a combination thereof, that include an indication of at least two precoders to apply to the at least two directional beams. In some examples, the SFN communication component 730 may be configured as or otherwise support a means for transmitting an uplink data channel via the at least two directional beams in accordance with the at least two precoders and the SFN communication scheme.

In some examples, the uplink data channel includes a codebook-based uplink data channel, and the two or more SRS resource indicators, the two or more transmit precoding indicators, or the combination thereof, indicate the at least two precoders associated with a SFN transmission of the one or more SRS.

In some examples, the uplink data channel includes a non-codebook-based uplink data channel, and the two or more SRS resource indicators indicate the at least two precoders associated with a SFN transmission of a subset of the one or more SRS.

In some examples, the control message includes an RRC message, and the SFN communication component 730 may be configured as or otherwise support a means for applying, in accordance with the RRC message, the SFN communication scheme for a SRS resource set associated with each of the one or more SRS.

In some examples, the control message includes an RRC message, and the SFN communication component 730 may be configured as or otherwise support a means for applying, in accordance with the RRC message, the SFN communication scheme for a SRS resource corresponding to at least one of the one or more SRS that are associated with a SRS resource set.

In some examples, to support transmitting the one or more SRS, the SFN communication component 730 may be configured as or otherwise support a means for transmitting the one or more aperiodic SRS via the at least two directional beams in accordance with the SFN communication scheme indicated by the DCI message.

In some examples, to support transmitting the one or more SRS, the SFN communication component 730 may be configured as or otherwise support a means for transmitting the one or more semi-periodic SRS via the at least two directional beams in accordance with the SFN communication scheme indicated by the DCI.

In some examples, to support transmitting the one or more SRS, the SFN communication component 730 may be configured as or otherwise support a means for transmitting the one or more periodic SRS via the at least two directional beams in accordance with the SFN communication scheme indicated by the RRC message.

In some examples, to support transmitting the one or more SRS, the SFN communication component 730 may be configured as or otherwise support a means for transmitting the one or more SRS in accordance with the SFN communication scheme based on the one or more SRS being associated with the at least two directional beams.

In some examples, the power control management component 740 may be configured as or otherwise support a means for receiving a DCI message that indicates one or more power control parameters corresponding to the at least two directional beams. In some examples, the power control management component 740 may be configured as or otherwise support a means for applying the one or more power control parameters to the at least two directional beams based on the DCI message.

In some examples, the one or more power control parameters include a first power control parameter and a second power control parameter, and the power control management component 740 may be configured as or otherwise support a means for applying the first power control parameter to a first directional beam of the at least two directional beams and the second power control parameter to a second directional beam of the at least two directional beams.

In some examples, the one or more power control parameters include a single power control parameter, and the power control management component 740 may be configured as or otherwise support a means for applying the single power control parameter separately to a first directional beam of the at least two directional beams and to a second directional beam of the at least two directional beams.

In some examples, the one or more power control parameters include a single power control parameter, and the power control management component 740 may be configured as or otherwise support a means for applying a first portion of the single power control parameter to a first directional beam of the at least two directional beams and a second portion of the single power control parameter to a second directional beam of the at least two directional beams.

In some examples, the DCI message includes a group common DCI message, a first DCI message format, a second DCI message format, or any combination thereof. In some examples, the at least two directional beams are associated with at least two unified TCI states, at least two spatial relation information parameters, or any combination thereof.

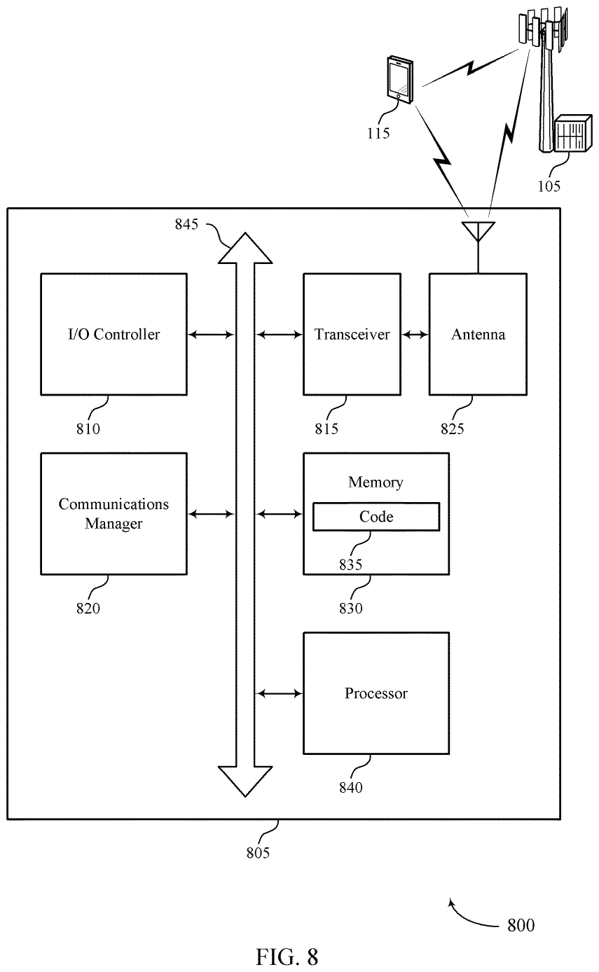

FIG. 8 illustrates a diagram of a system 800 including a device 805 that supports SFN transmission schemes for SRS in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be coupled (e.g., operatively, communicatively, functionally, electronically, or electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting SFN transmission schemes for SRS). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving a control message indicating a configuration of a SFN communication scheme for one or more SRS, where respective antenna ports of the UE for transmitting the one or more SRS are each associated with at least two directional beams. The communications manager 820 may be configured as or otherwise support a means for transmitting the one or more SRS via the at least two directional beams in accordance with the SFN communication scheme.

By including or configuring the communications manager 820 in accordance with examples as described herein, the device 805 may support techniques for improved communication reliability, reduced latency, improved user experience related to reduced processing, more efficient utilization of communication resources, improved coordination between devices, increased power savings, increased uplink throughput and reliability, increased coverage and extended support for SFN communications for uplink communications.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of SFN transmission schemes for SRS as described herein, or the processor 840 and the memory 830 may be otherwise configured to perform or support such operations.

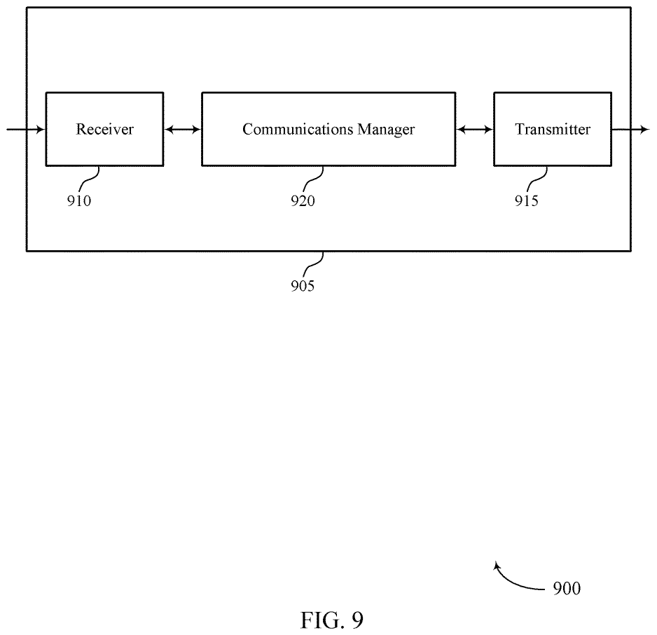

FIG. 9 illustrates a block diagram 900 of a device 905 that supports SFN transmission schemes for SRS in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of SFN transmission schemes for SRS as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, at least one processor and memory coupled with the at least one processor may be configured to perform one or more of the functions described herein (e.g., by executing, by the at least one processor, instructions stored in the memory).

Additionally, or alternatively, in some examples, the communications manager 920, the receiver 910, the transmitter 915, or various combinations or components thereof may be implemented in code (e.g., as communications management software) executed by a processor. If implemented in code executed by a processor, the functions of the communications manager 920, the receiver 910, the transmitter 915, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. For example, the communications manager 920 may be configured as or otherwise support a means for transmitting a control message indicating a configuration of a SFN communication scheme for one or more SRS, where the SFN communication scheme is configured for respective antenna ports associated with the one or more SRS that are each associated with at least two directional beams. The communications manager 920 may be configured as or otherwise support a means for receiving the one or more SRS via the at least two directional beams in accordance with the SFN communication scheme.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources, increased power savings, and increased throughput and reliability.

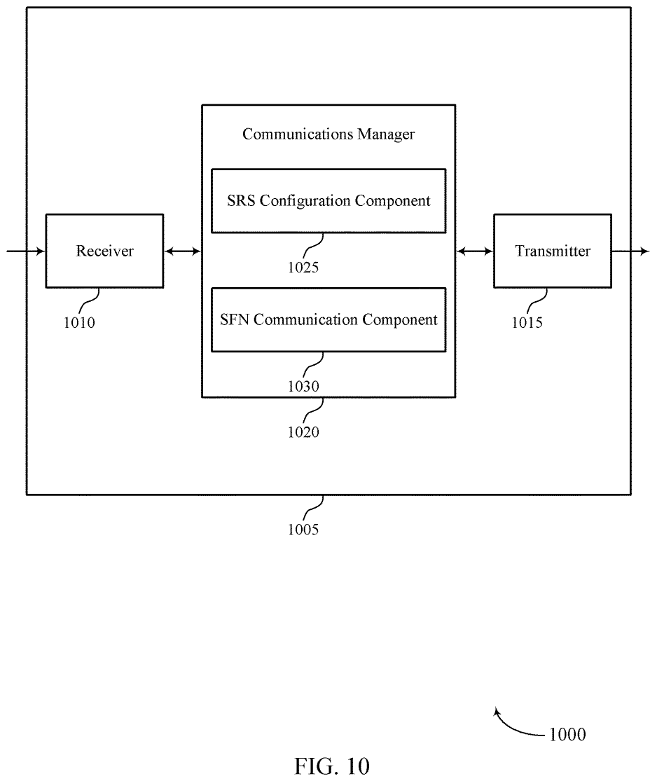

FIG. 10 illustrates a block diagram 1000 of a device 1005 that supports SFN transmission schemes for SRS in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of SFN transmission schemes for SRS as described herein. For example, the communications manager 1020 may include an SRS configuration component 1025 an SFN communication component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. The SRS configuration component 1025 may be configured as or otherwise support a means for transmitting a control message indicating a configuration of a SFN communication scheme for one or more SRS, where the SFN communication scheme is configured for respective antenna ports associated with the one or more SRS that are each associated with at least two directional beams. The SFN communication component 1030 may be configured as or otherwise support a means for receiving the one or more SRS via the at least two directional beams in accordance with the SFN communication scheme.

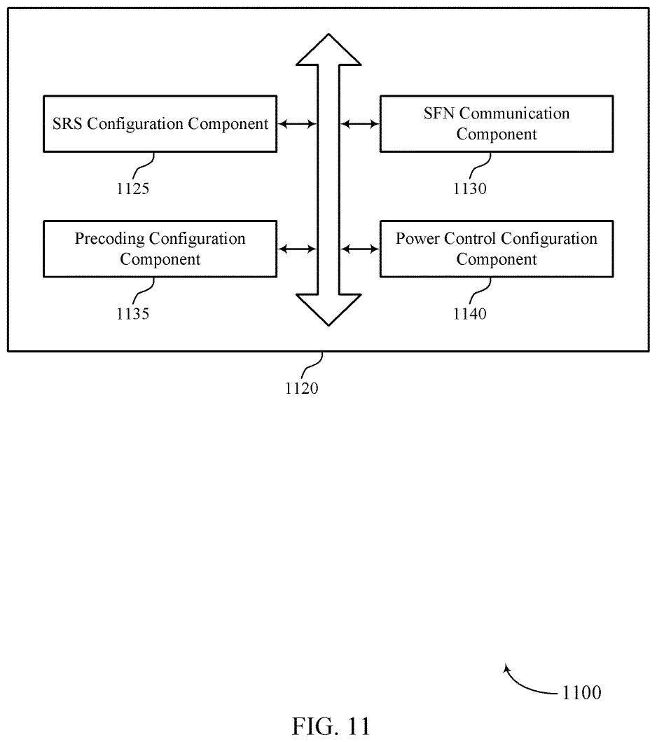

FIG. 11 illustrates a block diagram 1100 of a communications manager 1120 that supports SFN transmission schemes for SRS in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of SFN transmission schemes for SRS as described herein. For example, the communications manager 1120 may include an SRS configuration component 1125, an SFN communication component 1130, a precoding configuration component 1135, a power control configuration component 1140, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples as disclosed herein. The SRS configuration component 1125 may be configured as or otherwise support a means for transmitting a control message indicating a configuration of a SFN communication scheme for one or more SRS, where the SFN communication scheme is configured for respective antenna ports associated with the one or more SRS that are each associated with at least two directional beams. The SFN communication component 1130 may be configured as or otherwise support a means for receiving the one or more SRS via the at least two directional beams in accordance with the SFN communication scheme.

In some examples, the precoding configuration component 1135 may be configured as or otherwise support a means for transmitting one or more SRS resource indicators, one or more transmit precoding indicators, or any combination thereof, that include an indication of at least two precoders to apply to the at least two directional beams. In some examples, the SFN communication component 1130 may be configured as or otherwise support a means for receiving an uplink data channel via the at least two directional beams in accordance with the at least two precoders and the SFN communication scheme.

In some examples, to support receiving the one or more SRS, the SFN communication component 1130 may be configured as or otherwise support a means for receiving, based on the RRC message, each of the one or more SRS that are associated with a SRS resource set, the SRS resource set being configured with the SFN communication scheme.

In some examples, to support receiving the one or more SRS, the SFN communication component 1130 may be configured as or otherwise support a means for receiving, based on the RRC message, at least one of the one or more SRS that are associated with a SRS resource set, respective SRS resources associated with the at least one of the one or more SRS being configured with the SFN communication scheme.

In some examples, to support receiving the one or more SRS, the SFN communication component 1130 may be configured as or otherwise support a means for receiving the one or more aperiodic SRS via the at least two directional beams in accordance with the SFN communication scheme indicated by the DCI message.

In some examples, to support receiving the one or more SRS, the SFN communication component 1130 may be configured as or otherwise support a means for receiving the one or more semi-periodic SRS via the at least two directional beams in accordance with the SFN communication scheme indicated by the DCI.

In some examples, to support receiving the one or more SRS, the SFN communication component 1130 may be configured as or otherwise support a means for receiving the one or more periodic SRS via the at least two directional beams in accordance with the SFN communication scheme indicated by the RRC message.

In some examples, the power control configuration component 1140 may be configured as or otherwise support a means for transmitting a DCI message that indicates one or more power control parameters corresponding to the at least two directional beams. In some examples, the SFN communication component 1130 may be configured as or otherwise support a means for receiving signaling via the at least two directional beams based on the one or more power control parameters and the DCI message.

In some examples, the one or more power control parameters correspond to both a first directional beam of the at least two directional beams and a second directional beam of the at least two directional beams.

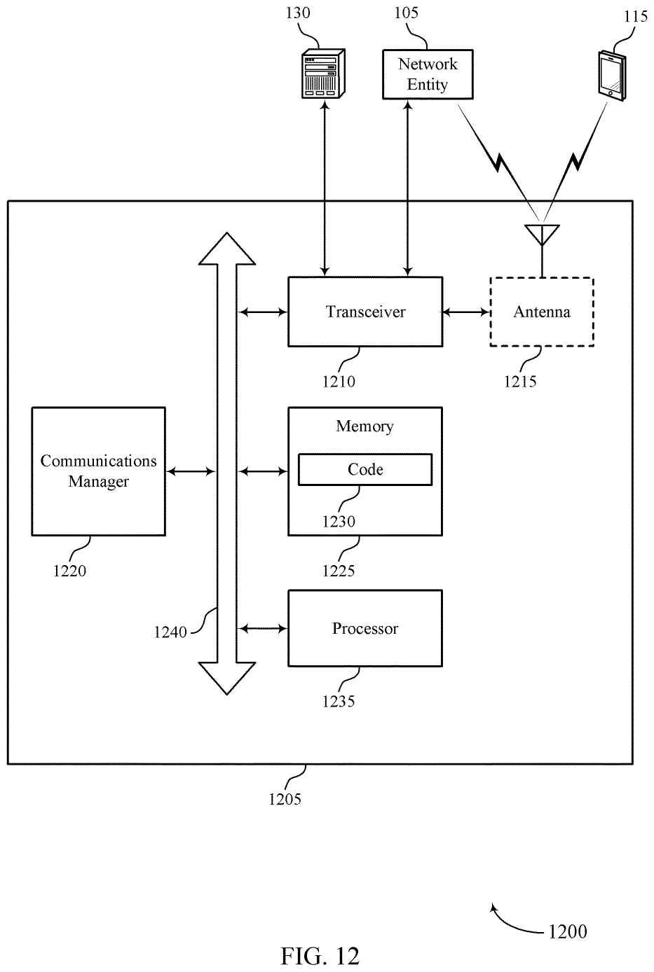

FIG. 12 illustrates a diagram of a system 1200 including a device 1205 that supports SFN transmission schemes for SRS in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting SFN transmission schemes for SRS). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a network entity in accordance with examples as disclosed herein. For example, the communications manager 1220 may be configured as or otherwise support a means for transmitting a control message indicating a configuration of a SFN communication scheme for one or more SRS, where the SFN communication scheme is configured for respective antenna ports associated with the one or more SRS that are each associated with at least two directional beams. The communications manager 1220 may be configured as or otherwise support a means for receiving the one or more SRS via the at least two directional beams in accordance with the SFN communication scheme.

By including or configuring the communications manager 1220 in accordance with examples as described herein, the device 1205 may support techniques for improved communication reliability, reduced latency, improved user experience related to reduced processing, more efficient utilization of communication resources, improved coordination between devices, increased power savings, increased uplink throughput and reliability, increased coverage and extended support for SFN communications for uplink communications.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of SFN transmission schemes for SRS as described herein, or the processor 1235 and the memory 1225 may be otherwise configured to perform or support such operations.

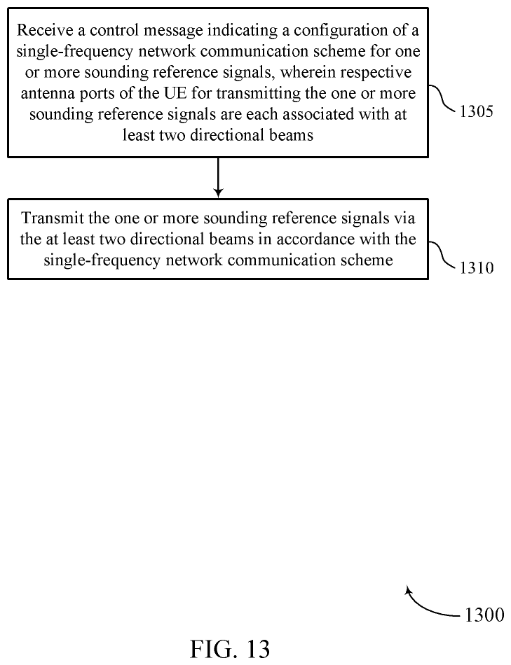

FIG. 13 illustrates a flowchart illustrating a method 1300 that supports SFN transmission schemes for SRS in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a control message indicating a configuration of a SFN communication scheme for one or more SRS, wherein respective antenna ports of the UE for transmitting the one or more SRS are each associated with at least two directional beams. The operations of 1305 may be performed in accordance with examples as disclosed herein. In some examples, aspects of the operations of 1305 may be performed by an SRS configuration component 725 as described with reference to FIG. 7.

At 1310, the method may include transmitting the one or more SRS via the at least two directional beams in accordance with the SFN communication scheme. The operations of 1310 may be performed in accordance with examples as disclosed herein. In some examples, aspects of the operations of 1310 may be performed by an SFN communication component 730 as described with reference to FIG. 7.

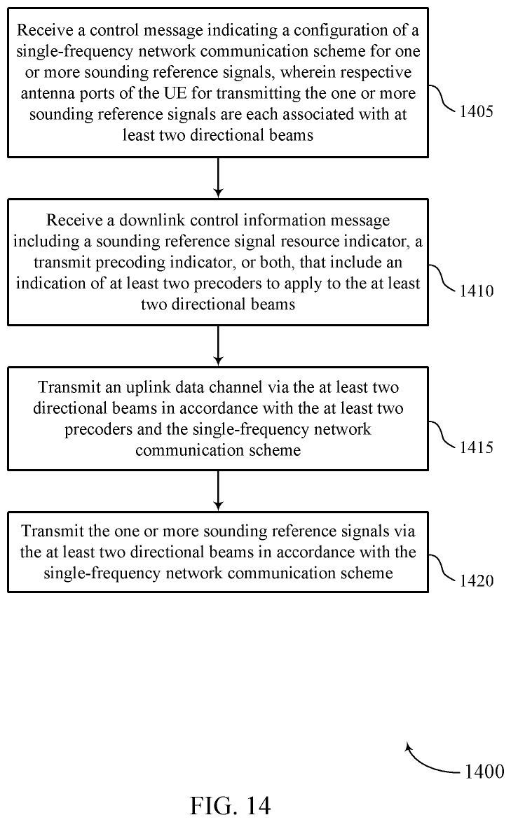

FIG. 14 illustrates a flowchart illustrating a method 1400 that supports SFN transmission schemes for SRS in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving a control message indicating a configuration of a SFN communication scheme for one or more SRS, wherein respective antenna ports of the UE for transmitting the one or more SRS are each associated with at least two directional beams. The operations of 1405 may be performed in accordance with examples as disclosed herein. In some examples, aspects of the operations of 1405 may be performed by an SRS configuration component 725 as described with reference to FIG. 7.

At 1410, the method may include receiving a DCI message including a SRS resource indicator, a transmit precoding indicator, or both, that include an indication of at least two precoders to apply to the at least two directional beams. The operations of 1410 may be performed in accordance with examples as disclosed herein. In some examples, aspects of the operations of 1410 may be performed by a precoding component 735 as described with reference to FIG. 7.

At 1415, the method may include transmitting an uplink data channel via the at least two directional beams in accordance with the at least two precoders and the SFN communication scheme. The operations of 1415 may be performed in accordance with examples as disclosed herein. In some examples, aspects of the operations of 1415 may be performed by an SFN communication component 730 as described with reference to FIG. 7.

At 1420, the method may include transmitting the one or more SRS via the at least two directional beams in accordance with the SFN communication scheme. The operations of 1420 may be performed in accordance with examples as disclosed herein. In some examples, aspects of the operations of 1420 may be performed by an SFN communication component 730 as described with reference to FIG. 7.

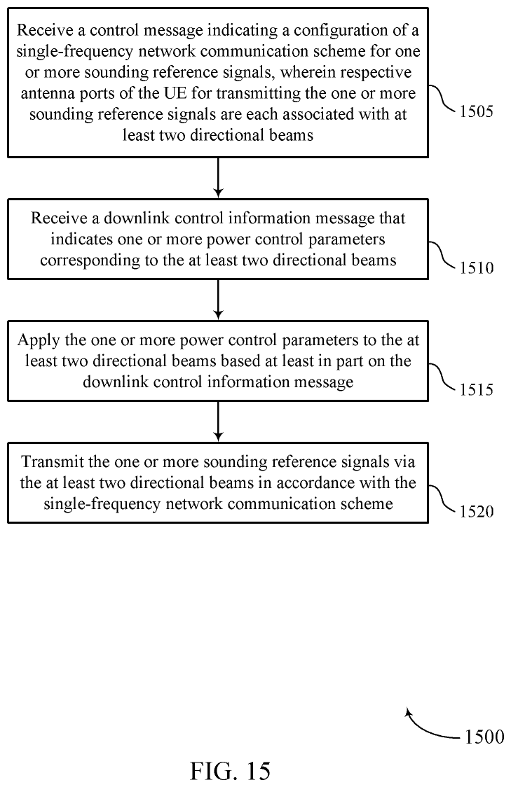

FIG. 15 illustrates a flowchart illustrating a method 1500 that supports SFN transmission schemes for SRS in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving a control message indicating a configuration of a SFN communication scheme for one or more SRS, wherein respective antenna ports of the UE for transmitting the one or more SRS are each associated with at least two directional beams. The operations of 1505 may be performed in accordance with examples as disclosed herein. In some examples, aspects of the operations of 1505 may be performed by an SRS configuration component 725 as described with reference to FIG. 7.

At 1510, the method may include receiving a DCI message that indicates one or more power control parameters corresponding to the at least two directional beams. The operations of 1510 may be performed in accordance with examples as disclosed herein. In some examples, aspects of the operations of 1510 may be performed by a power control management component 740 as described with reference to FIG. 7.

At 1515, the method may include applying the one or more power control parameters to the at least two directional beams based at least in part on the DCI message. The operations of 1515 may be performed in accordance with examples as disclosed herein. In some examples, aspects of the operations of 1515 may be performed by a power control management component 740 as described with reference to FIG. 7.

At 1520, the method may include transmitting the one or more SRS via the at least two directional beams in accordance with the SFN communication scheme. The operations of 1520 may be performed in accordance with examples as disclosed herein. In some examples, aspects of the operations of 1520 may be performed by an SFN communication component 730 as described with reference to FIG. 7.

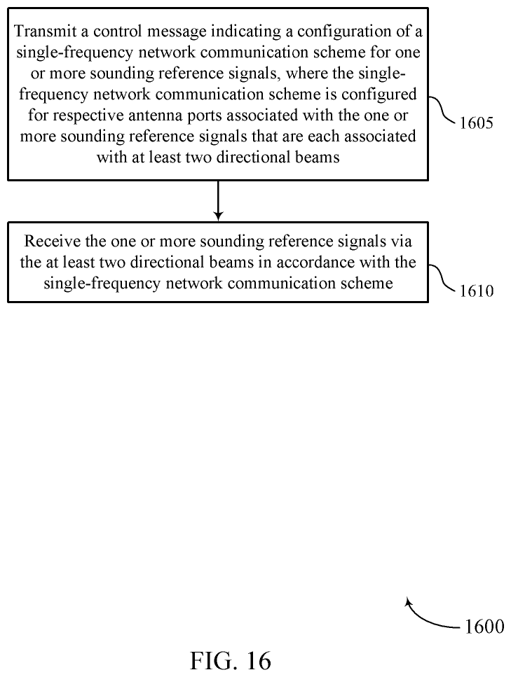

FIG. 16 illustrates a flowchart illustrating a method 1600 that supports SFN transmission schemes for SRS in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting a control message indicating a configuration of a SFN communication scheme for one or more SRS, wherein the SFN communication scheme is configured for respective antenna ports associated with the one or more SRS that are each associated with at least two directional beams. The operations of 1605 may be performed in accordance with examples as disclosed herein. In some examples, aspects of the operations of 1605 may be performed by an SRS configuration component 1125 as described with reference to FIG. 11.

At 1610, the method may include receiving the one or more SRS via the at least two directional beams in accordance with the SFN communication scheme. The operations of 1610 may be performed in accordance with examples as disclosed herein. In some examples, aspects of the operations of 1610 may be performed by an SFN communication component 1130 as described with reference to FIG. 11.

The following provides an overview of aspects of the present disclosure:

Aspect 1: A method for wireless communication at a UE, comprising: receiving a control message indicating a configuration of a SFN communication scheme for one or more SRSs, wherein respective antenna ports of the UE for transmitting the one or more SRSs are each associated with at least two directional beams; and transmitting the one or more SRSs via the at least two directional beams in accordance with the SFN communication scheme.

Aspect 2: The method of aspect 1, further comprising: receiving a DCI message comprising an SRI, a transmit precoding indicator, or both, that comprise an indication of at least two precoders to apply to the at least two directional beams; and transmitting an uplink data channel via the at least two directional beams in accordance with the at least two precoders and the SFN communication scheme.

Aspect 3: The method of aspect 2, wherein the uplink data channel comprises a codebook-based uplink data channel, and the at least two precoders are based at least in part on the at least two directional beams associated with the SFN communication scheme for transmitting the one or more SRSs.

Aspect 4: The method of any of aspects 2 through 3, wherein the uplink data channel comprises a non-codebook-based uplink data channel, and the at least two precoders are determined based at least in part on the at least two directional beams associated with the SFN communication scheme for transmitting a subset of the one or more SRSs.

Aspect 5: The method of any of aspects 1 through 4, further comprising: receiving two or more SRIs, two or more transmit precoding indicators, or a combination thereof, that comprise an indication of at least two precoders to apply to the at least two directional beams; and transmitting an uplink data channel via the at least two directional beams in accordance with the at least two precoders and the SFN communication scheme.

Aspect 6: The method of aspect 5, wherein the uplink data channel comprises a codebook-based uplink data channel, and the two or more SRIs, the two or more transmit precoding indicators, or the combination thereof, indicate the at least two precoders associated with a SFN transmission of the one or more SRSs.

Aspect 7: The method of any of aspects 5 through 6, wherein the uplink data channel comprises a non-codebook-based uplink data channel, and the two or more SRIs indicate the at least two precoders associated with a SFN transmission of a subset of the one or more SRSs.

Aspect 8: The method of any of aspects 1 through 7, wherein the control message comprises an RRC message, the method further comprising: applying, in accordance with the RRC message, the SFN communication scheme for a SRS resource set associated with each of the one or more SRSs.

Aspect 9: The method of any of aspects 1 through 8, wherein the control message comprises an RRC message, the method further comprising: applying, in accordance with the RRC message, the SFN communication scheme for a SRS resource corresponding to at least one of the one or more SRSs that are associated with a SRS resource set.

Aspect 10: The method of any of aspects 1 through 9, wherein the one or more SRSs comprise one or more aperiodic SRSs and the control message comprises a DCI message, and wherein transmitting the one or more SRSs further comprises: transmitting the one or more aperiodic SRSs via the at least two directional beams in accordance with the SFN communication scheme indicated by the DCI message.

Aspect 11: The method of any of aspects 1 through 10, wherein the one or more SRSs comprise one or more semi-periodic SRSs and the control message comprises a MAC-CE, and wherein transmitting the one or more SRSs further comprises: transmitting the one or more semi-periodic SRSs via the at least two directional beams in accordance with the SFN communication scheme indicated by the MAC-CE.

Aspect 12: The method of any of aspects 1 through 11, wherein the one or more SRSs comprise one or more periodic SRSs and the control message comprises an RRC message, and wherein transmitting the one or more SRSs further comprises: transmitting the one or more periodic SRSs via the at least two directional beams in accordance with the SFN communication scheme indicated by the RRC message.

Aspect 13: The method of any of aspects 1 through 12, wherein transmitting the one or more SRSs further comprises: transmitting the one or more SRSs in accordance with the SFN communication scheme based at least in part on the one or more SRSs being associated with the at least two directional beams.

Aspect 14: The method of any of aspects 1 through 13, further comprising: receiving a DCI message that indicates one or more power control parameters corresponding to the at least two directional beams; and applying the one or more power control parameters to the at least two directional beams based at least in part on the DCI message.

Aspect 15: The method of aspect 14, wherein the one or more power control parameters comprise a first power control parameter and a second power control parameter, the method further comprising: applying the first power control parameter to a first directional beam of the at least two directional beams and the second power control parameter to a second directional beam of the at least two directional beams.

Aspect 16: The method of any of aspects 14 through 15, wherein the one or more power control parameters comprise a single power control parameter, the method further comprising: applying the single power control parameter separately to a first directional beam of the at least two directional beams and to a second directional beam of the at least two directional beams.

Aspect 17: The method of any of aspects 14 through 16, wherein the one or more power control parameters comprise a single power control parameter, the method further comprising: applying a first portion of the single power control parameter to a first directional beam of the at least two directional beams and a second portion of the single power control parameter to a second directional beam of the at least two directional beams.

Aspect 18: The method of any of aspects 14 through 17, wherein the DCI message comprises a group common DCI message, a first DCI message format, a second DCI message format, or any combination thereof.

Aspect 19: The method of any of aspects 1 through 18, wherein the at least two directional beams are associated with at least two unified TCI states, at least two spatial relation information parameters, or any combination thereof.

Aspect 20: A method for wireless communication at a network entity, comprising: transmitting a control message indicating a configuration of a SFN communication scheme for one or more SRSs, wherein the SFN communication scheme is configured for respective antenna ports associated with the one or more SRSs that are each associated with at least two directional beams; and receiving the one or more SRSs via the at least two directional beams in accordance with the SFN communication scheme.

Aspect 21: The method of aspect 20, further comprising: transmitting one or more SRIs, one or more transmit precoding indicators, or any combination thereof, that comprise an indication of at least two precoders to apply to the at least two directional beams; and receiving an uplink data channel via the at least two directional beams in accordance with the at least two precoders and the SFN communication scheme.

Aspect 22: The method of any of aspects 20 through 21, wherein the control message comprises an RRC message, and wherein receiving the one or more SRSs comprises: receiving, based at least in part on the RRC message, each of the one or more SRSs that are associated with a SRS resource set, the SRS resource set being configured with the SFN communication scheme.

Aspect 23: The method of any of aspects 20 through 22, wherein the control message comprises an RRC message, and wherein receiving the one or more SRSs comprises: receiving, based at least in part on the RRC message, at least one of the one or more SRSs that are associated with a SRS resource set, respective SRS resources associated with the at least one of the one or more SRSs being configured with the SFN communication scheme.

Aspect 24: The method of any of aspects 20 through 23, wherein the one or more SRSs comprise one or more aperiodic SRSs and the control message comprises a DCI message, and wherein receiving the one or more SRSs comprises: receiving the one or more aperiodic SRSs via the at least two directional beams in accordance with the SFN communication scheme indicated by the DCI message.

Aspect 25: The method of any of aspects 20 through 24, wherein the one or more SRSs comprise one or more semi-periodic SRSs and the control message comprises a MAC-CE, and wherein receiving the one or more SRSs comprises: receiving the one or more semi-periodic SRSs via the at least two directional beams in accordance with the SFN communication scheme indicated by the MAC-CE.

Aspect 26: The method of any of aspects 20 through 25, wherein the one or more SRSs comprise one or more periodic SRSs and the control message comprises an RRC message, and wherein receiving the one or more SRSs comprises: receiving the one or more periodic SRSs via the at least two directional beams in accordance with the SFN communication scheme indicated by the RRC message.

Aspect 27: The method of any of aspects 20 through 26, further comprising: transmitting a DCI message that indicates one or more power control parameters corresponding to the at least two directional beams; and receiving signaling via the at least two directional beams based at least in part on the one or more power control parameters and the DCI message.

Aspect 28: The method of aspect 27, wherein the one or more power control parameters correspond to both a first directional beam of the at least two directional beams and a second directional beam of the at least two directional beams.

Aspect 29: An apparatus for wireless communication at a UE, comprising at least one processor; and memory coupled with the at least one processor, the memory storing instructions executable by the at least one processor to cause the UE to perform a method of any of aspects 1 through 19.

Aspect 30: An apparatus for wireless communication at a UE, comprising at least one means for performing a method of any of aspects 1 through 19.

Aspect 31: A non-transitory computer-readable medium storing code for wireless communication at a UE, the code comprising instructions executable by a processor to perform a method of any of aspects 1 through 19.

Aspect 32: An apparatus for wireless communication at a network entity, comprising at least one processor; and memory coupled with the at least one processor, the memory storing instructions executable by the at least one processor to cause the network entity to perform a method of any of aspects 20 through 28.

Aspect 33: An apparatus for wireless communication at a network entity, comprising at least one means for performing a method of any of aspects 20 through 28.

Aspect 34: A non-transitory computer-readable medium storing code for wireless communication at a network entity, the code comprising instructions executable by at least one processor to perform a method of any of aspects 20 through 28.

It should be noted that the methods described herein describe possible implementations, and that the operations and the steps may be rearranged or otherwise modified and that other implementations are possible. Further, aspects from two or more of the methods may be combined.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (e.g., Institute of Electrical and Electronics Engineers (IEEE) 802.11) network may include an access point (AP) that may communicate with one or more wireless or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a device may communicate with an associated AP via downlink (e.g., the communication link from the AP to the device) and uplink (e.g., the communication link from the device to the AP). A wireless personal area network (PAN), which may include a Bluetooth connection, may provide for short range wireless connections between two or more paired wireless devices. For example, wireless devices such as cellular phones may utilize wireless PAN communications to exchange information such as audio signals with wireless headsets. Components within a wireless communication system may be coupled (for example, operatively, communicatively, functionally, electronically, and/or electrically) to each other.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), IEEE 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the at least one processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software (e.g., executed by a processor), or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
at least one processor; and
memory coupled with the at least one processor, the at least one processor configurable via instructions stored in the memory to cause the UE to:
receive a control message indicating a configuration of a single-frequency network communication scheme for one or more sounding reference signals, wherein respective antenna ports of the UE for transmitting the one or more sounding reference signals are each associated with at least two directional beams; and
transmit the one or more sounding reference signals via the at least two directional beams in accordance with the single-frequency network communication scheme.

2. The apparatus of claim 1, wherein the at least one processor is further configurable via the instructions to cause the UE to:
receive a downlink control information message comprising a sounding reference signal resource indicator, a transmit precoding indicator, or both, that comprise an indication of at least two precoders to apply to the at least two directional beams; and
transmit an uplink data channel via the at least two directional beams in accordance with the at least two precoders and the single-frequency network communication scheme.

3. The apparatus of claim 2, wherein the uplink data channel comprises a codebook-based uplink data channel, and the at least two precoders are based at least in part on the at least two directional beams associated with the single-frequency network communication scheme for transmitting the one or more sounding reference signals.

4. The apparatus of claim 2, wherein the uplink data channel comprises a non-codebook-based uplink data channel, and the at least two precoders are determined based at least in part on the at least two directional beams associated with the single-frequency network communication scheme for transmitting a subset of the one or more sounding reference signals.

5. The apparatus of claim 1, wherein the at least one processor is further configurable via the instructions to cause the UE to:
receive two or more sounding reference signal resource indicators, two or more transmit precoding indicators, or a combination thereof, that comprise an indication of at least two precoders to apply to the at least two directional beams; and
transmit an uplink data channel via the at least two directional beams in accordance with the at least two precoders and the single-frequency network communication scheme.

6. The apparatus of claim 5, wherein the uplink data channel comprises a codebook-based uplink data channel, and the two or more sounding reference signal resource indicators, the two or more transmit precoding indicators, or the combination thereof, indicate the at least two precoders associated with a single-frequency network transmission of the one or more sounding reference signals.

7. The apparatus of claim 5, wherein the uplink data channel comprises a non-codebook-based uplink data channel, and the two or more sounding reference signal resource indicators indicate the at least two precoders associated with a single-frequency network transmission of a subset of the one or more sounding reference signals.

8. The apparatus of claim 1, wherein the control message comprises a radio resource control message, and the at least one processor is further configurable via the instructions to cause the UE to:
apply, in accordance with the radio resource control message, the single-frequency network communication scheme for a sounding reference signal resource set associated with each of the one or more sounding reference signals.

9. The apparatus of claim 1, wherein the control message comprises a radio resource control message, and the at least one processor is further configurable via the instructions to cause the UE to:
apply, in accordance with the radio resource control message, the single-frequency network communication scheme for a sounding reference signal resource corresponding to at least one of the one or more sounding reference signals that are associated with a sounding reference signal resource set.

10. The apparatus of claim 1, wherein the one or more sounding reference signals comprise one or more aperiodic sounding reference signals and the control message comprises a downlink control information message, and the at least one processor is further configurable via the instructions to transmit the one or more sounding reference signals and to cause the UE to:
transmit the one or more aperiodic sounding reference signals via the at least two directional beams in accordance with the single-frequency network communication scheme indicated by the downlink control information message.

11. The apparatus of claim 1, wherein the one or more sounding reference signals comprise one or more semi-periodic sounding reference signals and the control message comprises a medium access control-control element, and the at least one processor is further configurable via the instructions to transmit the one or more sounding reference signals and to cause the UE to:
transmit the one or more semi-periodic sounding reference signals via the at least two directional beams in accordance with the single-frequency network communication scheme indicated by the medium access control-control element.

12. The apparatus of claim 1, wherein the one or more sounding reference signals comprise one or more periodic sounding reference signals and the control message comprises a radio resource control message, and the at least one processor is further configurable via the instructions to transmit the one or more sounding reference signals and to cause the UE to:
transmit the one or more periodic sounding reference signals via the at least two directional beams in accordance with the single-frequency network communication scheme indicated by the radio resource control message.

13. The apparatus of claim 1, wherein the at least one processor is further configurable via the instructions to transmit the one or more sounding reference signals and to cause the UE to:
transmit the one or more sounding reference signals in accordance with the single-frequency network communication scheme based at least in part on the one or more sounding reference signals being associated with the at least two directional beams.

14. The apparatus of claim 1, wherein the at least one processor is further configurable via the instructions to cause the UE to:
receive a downlink control information message that indicates one or more power control parameters corresponding to the at least two directional beams; and
apply the one or more power control parameters to the at least two directional beams based at least in part on the downlink control information message.

15. The apparatus of claim 14, wherein the one or more power control parameters comprise a first power control parameter and a second power control parameter, and the at least one processor is further configurable via the instructions to cause the UE to:
apply the first power control parameter to a first directional beam of the at least two directional beams and the second power control parameter to a second directional beam of the at least two directional beams.

16. The apparatus of claim 14, wherein the one or more power control parameters comprise a single power control parameter, and the at least one processor is further configurable via the instructions to cause the UE to:
apply the single power control parameter separately to a first directional beam of the at least two directional beams and to a second directional beam of the at least two directional beams.

17. The apparatus of claim 14, wherein the one or more power control parameters comprise a single power control parameter, and the at least one processor is further configurable via the instructions to cause the UE to:
apply a first portion of the single power control parameter to a first directional beam of the at least two directional beams and a second portion of the single power control parameter to a second directional beam of the at least two directional beams.

18. (canceled)

19. The apparatus of claim 1, wherein the at least two directional beams are associated with at least two unified transmission configuration indicator states, at least two spatial relation information parameters, or any combination thereof.

20. An apparatus for wireless communication at a network entity, comprising:
at least one processor; and
memory coupled with the at least one processor, the at least one processor configurable via instructions stored in the memory to cause the network entity to:
transmit a control message indicating a configuration of a single-frequency network communication scheme for one or more sounding reference signals, wherein the single-frequency network communication scheme is configured for respective antenna ports associated with the one or more sounding reference signals that are each associated with at least two directional beams; and
receive the one or more sounding reference signals via the at least two directional beams in accordance with the single-frequency network communication scheme.

21.-28. (canceled)

29. A method for wireless communication at a user equipment (UE), comprising:
receiving a control message indicating a configuration of a single-frequency network communication scheme for one or more sounding reference signals, wherein respective antenna ports of the UE for transmitting the one or more sounding reference signals are each associated with at least two directional beams, and
transmitting the one or more sounding reference signals via the at least two directional beams in accordance with the single-frequency network communication scheme.

30. (canceled)
